(19) United States
(12) Patent Application Publication
(10) Pub. No.: US 2013/0238646 A1
(43) Pub. Date: Sep. 12, 2013

(54) Partial-Match Searches of Encrypted Data Sets

(71) Applicant: Anthony W. Maro, White Sulphur Springs, WV (US)

(72) Inventor: Anthony W. Maro, White Sulphur Springs, WV (US)

(73) Assignee: EVRICHART, INC., Roanoke, VA (US)

(21) Appl. No.: 13/413,238

(22) Filed: Mar. 6, 2012

(51) Int. Cl. G06F 17/30

(52) U.S. Cl. 707/758; 707/E17.135

(57) ABSTRACT

Devices, systems, and methods are disclosed which relate to utilizing hash tables of chunks of index data created using a one-way hashing encryption algorithm. Hash tables of chunks of the index data are then stored within the database system, each hash stored along with a reference to a corresponding encrypted record. When searching the index, the input text is broken into chunks and hashed with the same one-way encryption algorithm as the index data, and the resulting chunk hash tables are searched for within the index.

### BACKGROUND OF THE SUBJECT DISCLOSURE

1. Field of the Subject Disclosure

The present subject disclosure relates to database management. More specifically, the present subject disclosure relates to partial-match searches of encrypted data sets.

2. Background of the Subject Disclosure

Data security, specifically security of Personal Health Information (PHI) requires that the data be stored in an encrypted format. For medical records, even the medical record number needs to be encrypted. For this data to be accessible and, more importantly, searchable, the data must be decrypted prior to being accessed. Data storage systems store most if not all of this information in an unencrypted state in order to facilitate searches. Particularly, if a data field is to allow partial match searches (such as part of a name or address) this searchable data or at least an index of the data must be stored in an unencrypted form. This exposes some or all of the data to potential hacking or data leakage.

### SUMMARY OF THE SUBJECT DISCLOSURE

The subject disclosure circumvents the above problems by utilizing hash tables of chunks of the index data created using a one-way hashing encryption algorithm. In exemplary embodiments of the subject disclosure, hash tables of chunks of the index data are then stored within the database system, each hash stored along with a reference to a corresponding encrypted record. When searching the index, the input text is broken into chunks and hashed with the same one-way encryption algorithm as the index data, and the resulting chunk hash tables are searched for within the index. Each matching entry is assigned a weight proportional to the number of matching chunks in the search result. The matching entries are then sorted by weight before being displayed.

In one exemplary embodiment, the present subject disclosure is a method for searching an encrypted database for a partial-match of a search string, the encrypted database including an index having a plurality of values and value chunks, each value having been broken into a plurality of value chunks, the index encrypted using a one-way encryption function. The method includes breaking the search string into a plurality of search chunks. The search string and the plurality of search chunks are encrypted using the one-way encryption function prior to a comparison with the index to determine a matching value.

In another exemplary embodiment, the present subject disclosure is a system for partial-match searching an encrypted database. The system includes a database server in communication with a search input system, a database in communication with the server, the database storing a plurality of records and an index, the plurality of records encrypted using a two-way encryption function and the index encrypted using a one-way encryption function, and a database query logic on the database server for breaking the search string into a plurality of search chunks, encrypting the search string and each search chunk using the one-way encryption function, and comparing the encrypted search string and each encrypted search chunk with the index to determine a matching value, the index having a plurality of values and value chunks, each value having been broken into a plurality of value chunks.

In yet another exemplary embodiment, the present subject disclosure is a computer-readable medium storing computer-readable instructions that, when executed by a processor, partial-search an encrypted database. The computer-readable medium including an instruction to break a search string into a plurality of search chunks, an instruction to encrypt the search string and each search chunk using a one-way encryption function, and an instruction to compare the encrypted search string and each search chunk to an index of the encrypted database to determine a matching value, the index having a plurality of values and value chunks, each value having been broken into a plurality of value chunks, the index encrypted using the one-way encryption function.

### BRIEF DESCRIPTION OF THE DRAWINGS

FIG. 1 shows a functional diagram of a system for partial match searches of an encrypted data set, according to an exemplary embodiment of the present subject disclosure.

FIG. 2 shows a system for partial match searches of an encrypted data set, according to an exemplary embodiment of the present subject disclosure.

FIG. 3 shows a method for partial-match searching an encrypted data set, according to an exemplary embodiment of the present subject disclosure.

FIG. 4 shows a partial-match search of an encrypted data set, according to an exemplary embodiment of the present subject disclosure.

FIG. 5 shows a search input interface for partial-match searching an encrypted data set, according to an exemplary embodiment of the present subject disclosure.

FIG. 6 shows a method for acquiring a record from a result of a partial-match search of an encrypted data set, according to an exemplary embodiment of the present subject disclosure.

FIG. 7 shows an interface for requesting a record from a result of a partial-match search of an encrypted data set, according to an exemplary embodiment of the present subject disclosure.

### DETAILED DESCRIPTION OF THE SUBJECT DISCLOSURE

The subject disclosure includes exemplary embodiments of systems, methods, and devices for performing partial-match searches of an encrypted data set. A search input system receives search strings from users or other systems, and forwards each search string to an input preprocessor. The user or system may also pass a decryption key along with the search string so that the result may be decrypted before being returned. The input preprocessor breaks each search string into a plurality of search chunks, and encrypts each search string along with the each of the plurality of search chunks using a salt function.

A database query processor receives the encrypted search string and corresponding encrypted search chunks, and compares the encrypted search string and encrypted search chunks with an encrypted index stored on a data storage system. The encrypted index contains encrypted values and a plurality of encrypted value chunks for each value. The value and value chunks are encrypted in a substantially similar manner to the search string. Each encrypted value and encrypted value chunk is associated with an encrypted record stored in the encrypted database.

A weight may be assigned to each encrypted record associated with a matching value or value chunk. The assigned weight is proportional to the number of matching values and value chunks for that encrypted record. For each matching encrypted record, the data query processor retrieves the matching encrypted value from the encrypted record in the encrypted database and adds the encrypted value and the assigned weight to a result. Results populated with all matching encrypted values for each matching record, and assigned weights, are forwarded to a decryption system, where the result may be decrypted and returned to the search input system, to eventually be viewed by or returned to the querying user or system.

“Record”, as used herein and throughout this disclosure, refers to a collection of values pertaining to a single subject. An example of a record includes medical records, where the subject is a person, and where the values represent data within the record. Each value within a record may have an associated field. In the medical record example, a field labeled “name” may be filled with a value of “Jonathan Doe”.

“Index”, as used herein and throughout this disclosure, refers to a collection of values from the records within a database. Each value is associated with a reference to the respective record.

“Reference”, as used herein and throughout this disclosure, refers to a pointer, address, or other unique identifier of a record within a database.

“Logic”, as used herein and throughout this disclosure, refers to any instructions or data that, when executed by a processor, performs functions. Logic may be formed from instructions stored in a device memory, a hard drive, a removable memory, or any other computer-readable medium.

Devices communicate with each other and with other network elements via a network, such as a wireless network, a wireline network, etc. A “network” can include broadband wide-area networks such as cellular networks, local-area networks (LAN), and personal area networks, such as near-field communication (NFC) networks including BLUETOOTH®.

There are many different ways to embody the subject disclosure. For simplicity, the following example embodiments present, for the most part, a minimal amount of structure necessary to achieve the functions of the subject disclosure. In many of the following example embodiments, one device, network, terminal, memory, logic, etc. is shown where a plurality may be used in tandem to achieve the same function. Those having skill in the art will recognize these pluralities, which are within the scope of the subject disclosure.

For the following description, it can be assumed that most correspondingly labeled structures across the figures (e.g., 220 and 420, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

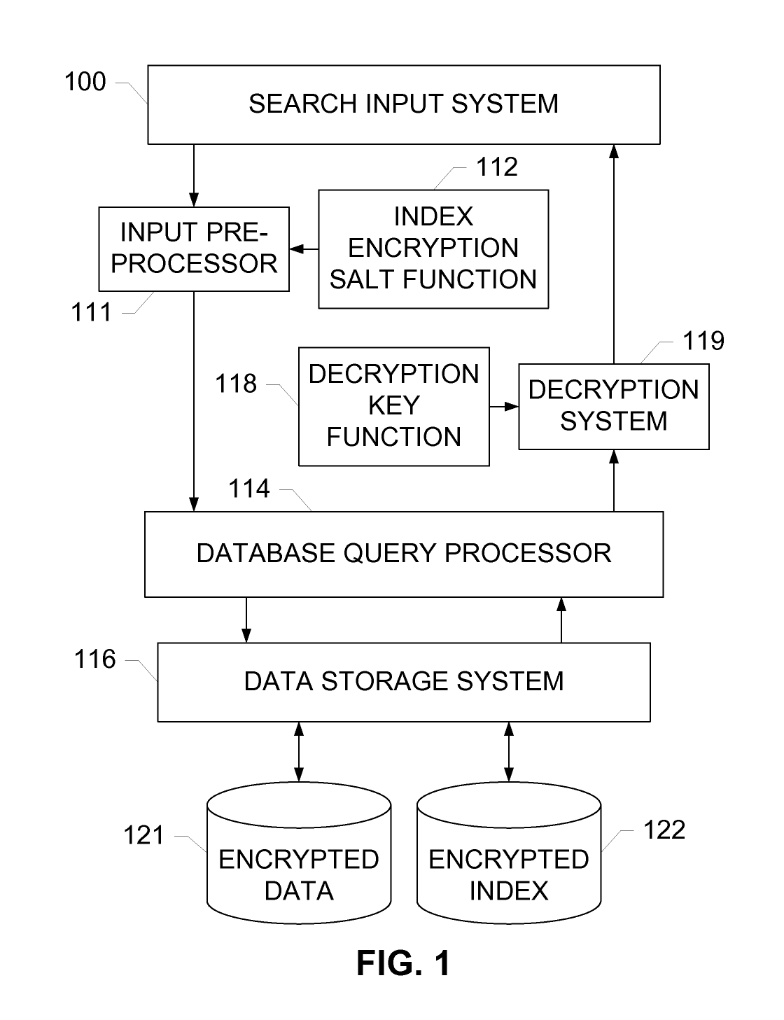

FIG. 1 shows a functional diagram of a system for partial match searches of an encrypted data set, according to an exemplary embodiment of the present subject disclosure. The system includes a search input system 100, an input preprocessor 111, an index encryption salt function 112, a database query processor 114, a data storage system 116, a decryption key function 118, a decryption system 119, an encrypted database 121, and an encrypted index database 122.

According to exemplary embodiments of the present subject disclosure, search input system 100 receives search strings from users or other systems, and forwards each search string to input preprocessor 111. For instance, search strings may be received at search input system 100 from other entities on a network, whether automated, or input by users of remote terminals. The user or system may also pass a decryption key along with the search string so that the result may be decrypted before return. In either case, input preprocessor breaks each search string into a plurality of chunks, and then encrypts each search string along with the plurality of chunks using index encryption salt function 112. When performing one-way encryption, a salt, which is unique to the data set, is used in order to keep the data secure. In cryptography, a salt consists of random bits, creating one of the inputs to a one-way function, such as the one-way encryption described herein. Database query processor 114 receives encrypted search strings and encrypted chunks, and compares the encrypted search string and encrypted chunks with encrypted index 122 via an interface with data storage system 116.

Encrypted index 122 contains encrypted values and a plurality of encrypted chunks for each value. In order for an encrypted index to be partial-match searched, the encrypted index is prepared by breaking each value into value chunks, and then encrypting each value chunk with encryption function 112. Encrypting function 112 encrypts each value chunk in a substantially similar manner to the functions input preprocessor 111 performs on each search string. This preparation of encrypted index 122 allows database query processor 114 to match encrypted values without having to perform encryptions or decryptions on the fly during the search process. Each encrypted value and encrypted value chunk is associated with an encrypted record stored in encrypted database 121.

Data query processor 114 assigns a weight to each encrypted record associated with a matching value or value chunk. The assigned weight is proportional to the number of matching values and value chunks for that encrypted record. For each matching encrypted record, data query processor 114 retrieves the matching encrypted value from the encrypted record in encrypted database 121, and adds the encrypted value and the assigned weight to a result. Once the result has been populated with all matching encrypted values for each matching record, and assigned weights, the result is forwarded to decryption system 119, where the result is decrypted using decryption function 118. Decryption system 119 returns the decrypted result to search input system 100, where the result is viewed by the user or system that input the search string. The result may be viewed or displayed in order of weight, or any other factor preferred by the user or system.

In an exemplary embodiment of the present subject disclosure, input preprocessor 111 resides on a system with sufficient processing power to perform the preprocessing functions. Input preprocessor 111 receives the index encryption salt from the index encryption salt function 112. The salt is used along with the search string to mathematically produce an encrypted string that cannot be decrypted, making it a one-way encryption function.

The search string may be normalized in a way that makes sense for the type of value being searched. For instance when names, addresses and numbers are searched within the database, the search string is converted by input preprocessor 111 into all uppercase letters, numbers and spaces, and then stripping out any other characters that may be in the input text.

The search string is then encrypted with encryption function 112, utilizing the provided encryption salt, to be used as one of the search match functions which would provide an “exact match” on the search string. In addition, the search string is broken into search chunks in such a way that makes sense for the type of value being searched. In a database storing names or addresses, for instance, the search chunks may be created by breaking the search string into separate words, then each word into a search chunk of at least three characters in length. Each of these search chunks of the search string is then encrypted with encryption function 112 by input preprocessor 111. The encrypted search string, along with each encrypted search chunk, is then fed to database query processor 114, which utilizes the interface to data storage system 116 to perform the search.

The result from this search may not be exclusive to all matches. Any number of search chunks may match value chunks from a record and return, within the search result, the matching value from the record. The number of matching value chunks of a given record are counted and used in a weighting algorithm to sort the result by the records most likely to be positive. Exact matches can be used to increase a record's weight even more to ensure that exact full-text matches are listed as highly likely to be positive.

Decryption of the result returned by the database query processor 114 is performed by decryption system 119 utilizing decryption key function 118. Decryption system 119 also decrypts records requested by the user through search input system 100. It is also possible for database query processor 114 to return requested records in an encrypted state, which are then decrypted by either search input system 100 or another system, providing an additional layer of data security while the search result is in transport.

In various exemplary embodiments of the present subject disclosure, the search input system may be presented in the form of a web browser interface, client application or applet on a mobile device, etc. The search input system may also be an interface to another system that needs to access and search encrypted data. The input preprocessor requires minimum processing power and may exist along with either the database query processor, the search input system, or combinations thereof in other exemplary embodiments.

In further embodiments, a device including the search input system utilizes integrated circuits to perform the tasks of the input preprocessor and the decryption system. These devices communicate with servers including the database query processor to perform a search through wired or wireless communication. An encrypted medical record system can be searched using tablet computers including integrated circuits that perform the encryption and decryption, which frees other resources of the tablet computer ultimately resulting in a faster search. An encrypted wiretap log index can be searched using a mobile device including integrated circuits that perform the encryption and decryption. Devices including integrated circuits or any onboard encryption and decryption systems send and receive only encrypted information to and from the database query processor, securing communication.

As described above, index encryption salt function 112 provides a secret key that is used to generate one-way encrypted hashes of chunks of input search strings. In other exemplary embodiments, this salt function may be retained with the input preprocessor or may be interfaced with an external system to provide an additional layer of security. A unique key can be generated for a specific data set. Multiple data sets can be stored within a single database, with a single key unlocking no more than one data set.

In some exemplary embodiments the database query processor can be a separate system, while in other exemplary embodiments the database query processor resides on the same system as the other components, requiring enough processing power to perform real-time searches on the dataset. Some implementations vary the processing power required, which may depend upon the volume of data to be stored and searched, latency requirements, size of the network, etc.

In other exemplary embodiments, the data storage system can be a relational database system or a NoSQL, document or key-value store database system, or any other system that provides at least basic search capabilities and providing enough physical storage space for storage of data or documents.

Further, the decryption system may reside with the database query processor, or on an entirely different system, based on the implementation. The decryption system may require enough processing power to continually decrypt the stored data as it is requested by the search input system. Alternatively, decrypting, searching, and transmitting tasks may be batched for optimal performance. For instance, queries may be prioritized based on source, complexity, number of search chunks, connection type, etc., and performed at different times with higher-priority queries being performed first.

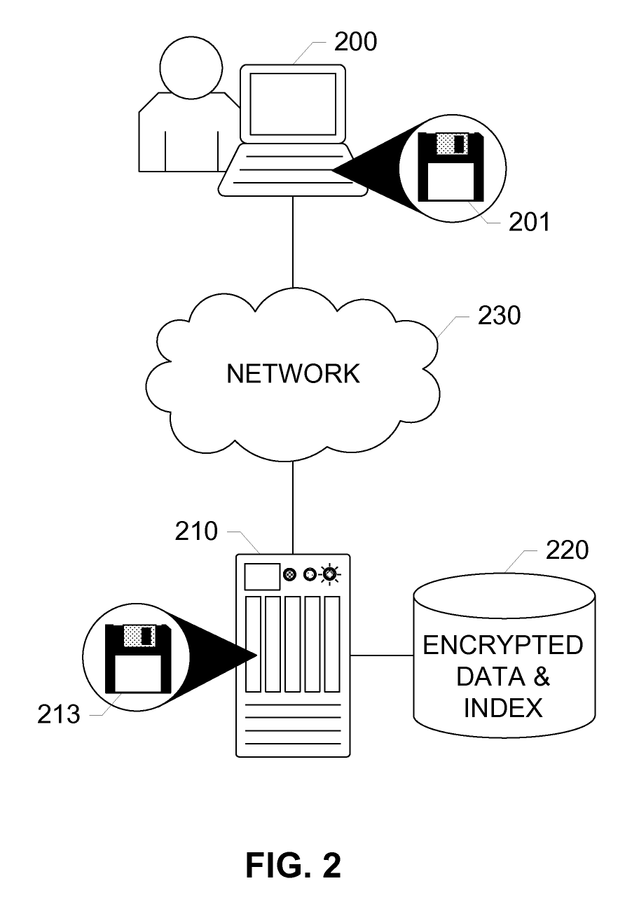

FIG. 2 shows a system for partial-match searches of an encrypted data set, according to an exemplary embodiment of the present subject disclosure. The system includes a search input terminal 200 storing a search input logic 201, a network 230 in communication with search input terminal 200, a database query processor 210 in communication with network 230, storing database query logic 213, and encrypted database 220. Search input terminal 200 is used by a user to input a search string. Search input logic 201 is stored on a computer-readable medium, and when executed by a processor of search input system 200, creates and presents a user interface for entering the search string, and transmits the search string through network 230 to database query processor 210. The search string is sent from search input system 200 to database query processor 210 through a web portal, virtual private network (VPN), etc. In some embodiments, search input logic is further for receiving a query or search string from another network entity, and forwarding the search string to database query processor 210. Combinations of human and computer input are possible.

Once the search string is received by database query processor 210, database query logic 213, which is stored on a computer-readable medium, is executed by a processor to perform each of the remaining functions to return a search result. For instance, database query logic 213 receives encrypted search strings and encrypted search chunks, compares the encrypted search string and encrypted search chunks with an encrypted index, matches encrypted values with their associated encrypted records stored in the encrypted database, assigns a weight to each encrypted record associated with a matching value or value chunk, retrieves the matching encrypted value from the encrypted record, and adds the encrypted value and the assigned weight to a result to be forwarded to a decryption system.

In other exemplary embodiments, the search logic can include the functions of the input-preprocessor instead of these functions being included in the database query logic.

Database query logic 213 encrypts the search string with a one-way “salt” encryption function. In addition, database query logic 213 breaks the search string into search chunks. Each of these search chunks of the search string is then encrypted with the one-way encryption function. The search for the encrypted search string and each encrypted search chunk in encrypted database 220 is then performed. Database query logic 213 collects the matching value from each matching record, along with a weight proportional to the number of matching search chunks, as described herein. The result is then decrypted utilizing a two-way decryption key function. Database query logic 213 also decrypts records requested by the user through search input terminal 200.

Network 230 is a wide-area network, such as the Internet. In other exemplary embodiments, the network can be a local area network, a WiFi network, a personal area network, etc., utilizing any wired and wireless communication. The search input terminal can be any computing device such as a personal computer, laptop computer, tablet computer, etc. Even handheld devices like personal digital assistants (PDAs), smart phones, and digital music players may act as search input systems.

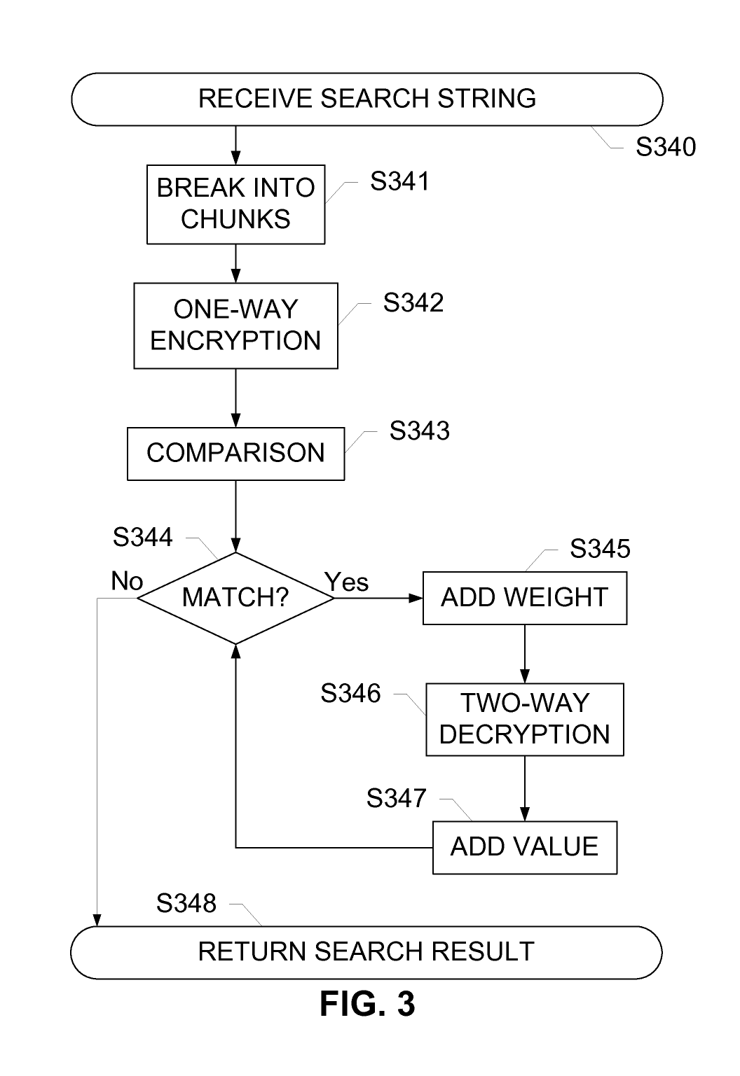

FIG. 3 shows a method for partial-match searching an encrypted data set, according to an exemplary embodiment of the present subject disclosure. When a database query processor (or any other partial-match search system for encrypted databases) receives a search string (S340), the search string is broken into search chunks (S341) in such a way that makes sense for the type of value being searched. Once broken into chunks, the search string and each associated chunk are encrypted using a one-way encryption function (S342). Each of the encrypted search string and encrypted search chunks is then compared with each encrypted value and encrypted value chunk of an encrypted index of a database, the encrypted index previously prepared for partial-match searching (S343).

As the encrypted values and value chunks of the encrypted index are searched (S344), weight is added to each matching value (S345) every time an encrypted chunk matches the value or its chunks. If the value is an exact match to the search string, then additional weight is added to the matching value. The matching value is then decrypted from the associated record using the two-way function with which the record was encrypted (S346). The decrypted matching value and the assigned weight are added to the search result (S347). Once all the matching values have been found, the search result is returned to the entity providing the search string (S348). The entity may be a search input system as previously described herein, or any other system for providing a search string. The search result may be returned (S348) in an order corresponding to their assigned weights. Alternatively, the search result may be returned (S348) along with the assigned weights, enabling the receiving entity to display the weighted results, or to sort the results based on any other specified criteria.

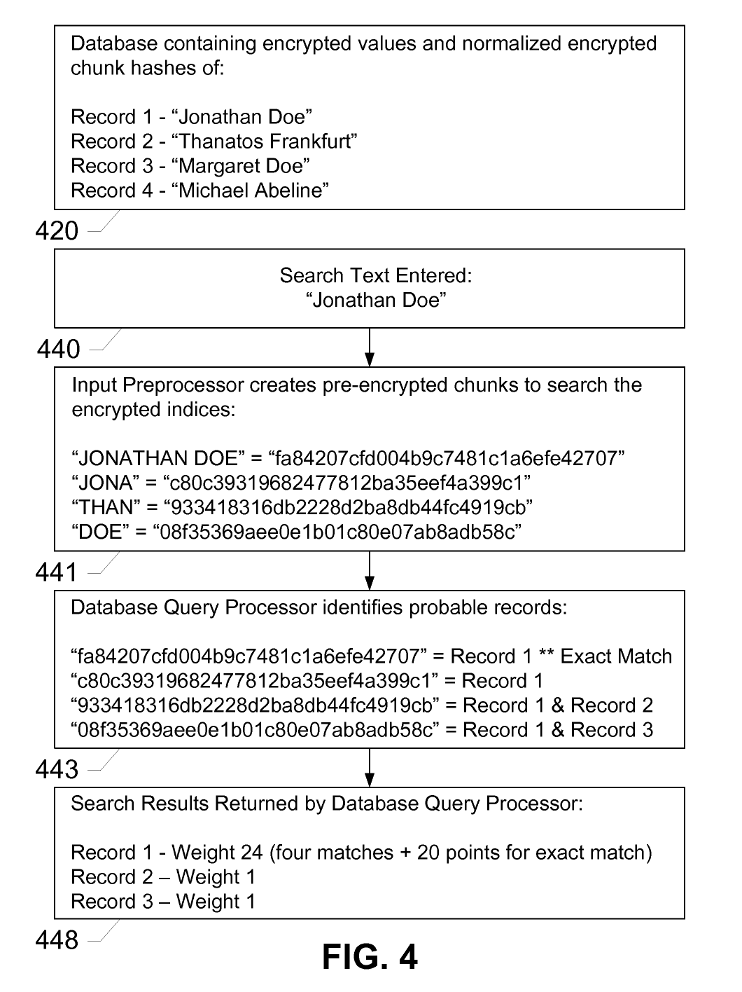

FIG. 4 shows an example partial-match search of an encrypted data set 420, according to an exemplary embodiment of the present subject disclosure. Encrypted data set 420 includes records numbered 1-4, each record having a value. In the present embodiment, each value shows the contents of what may be a name field of the corresponding record. These values are normalized, broken into value chunks, and encrypted to form an encrypted index for encrypted data set 420. The values are normalized and broken into value chunks in a way that makes sense for names.

A search string 440 has been entered into an input preprocessor that normalizes, breaks into search chunks, and encrypts search string 440 in a way that makes sense for names. The input preprocessor normalizes search string 440 by capitalizing every letter, and breaks search string 440 into chunks including a chunk of the last name alone. Though the whole first name is not used, a search of either portion of the first name will result in a match of a value identical to the whole first name of search string 440. The input preprocessor then sends encrypted search string 441 to a database query processor.

The database query processor finds a plurality of matches 443 for each chunk within encrypted search string 441. Each record added to plurality of matches 443 is added to a result 448 by the database query processor. The database query processor assigns each record in plurality of matches 443 a weight proportional to the number of chunks that match either the value or one of the chunks of the value for that record. If the value for that record matches search string 440 exactly, then additional weight is added to the record. In plurality of matches 443, Record 1 matches all three chunks and matches search string 440 exactly. Result 448 displays Record 1 first, with 24 points. Since Records 2 and 3 each matched only one chunk, these records are added to result 448 below Record 1, each with a weight of 1. A user viewing these results will recognize that Record 1 is clearly the closest match. Further, instead of additional weight, a flag may be added to the record that is clearly the closest match, enabling the record to be displayed first, with the remaining matches being displayed in order of weight.

The example database in FIG. 4 is greatly simplified in that there are only 4 records, and each record consists of a single value that is a full name. However, the same process may be applied for a database having millions of records, each record having hundreds of values. Any value of a record can be searched, and complex searches may involve searching more than one value at the same time. For example, a search string can include a first name and a birth date. The first name included in the search string is matched with first name values while the birth date included in the search string is matched with birth date values. A result of this search may yield records that include either the first name or the birth date from the search string, but records that match both the first name and the birth date will be assigned more weight and/or flagged.

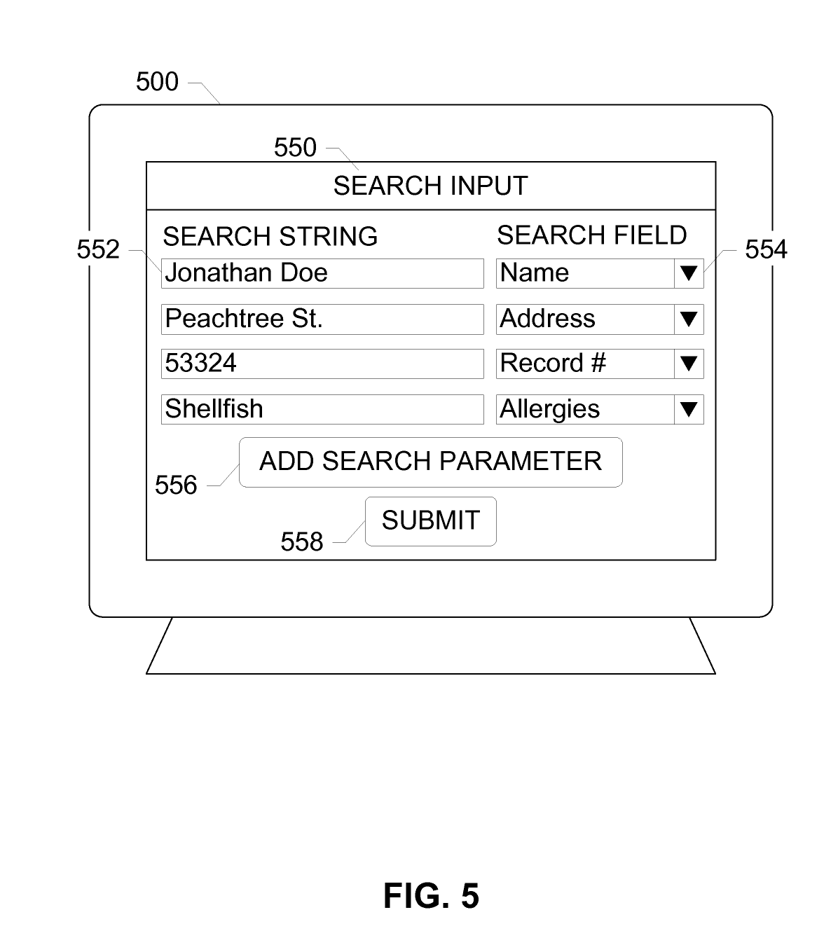

FIG. 5 shows an interface for search input 550 for partial-match searching an encrypted data set, according to an exemplary embodiment of the present subject disclosure. Search input 550 is displayed on a search input terminal 500, and includes a search string entry 552 having an associated search field 554, an add button 556, and a submission button 558. A user of search input terminal 500 enters a search string, “Jonathan Doe” into search string entry 552. In this exemplary embodiment, each record of the database being searched has multiple values. Each value within a record is defined by the type of information of that value. The field associated with search string 552 is a name, while other search strings are shown associated with an address, a record number, and allergy information. Since search string 552 is a name, name has been selected in search field 554.

Though a search can be performed using only a single search string and associated value, this exemplary embodiment shows a more complex search, involving four different values. The user is searching for a medical record, but only has some values to search with. In order to enter more than one search string, the user activates add button 556. If the user has more values, add button 556 can be activated once for every additional search string the user wishes to input. Multiple search strings may exist for the same field. When the user has entered all desired search strings, submission button 558 is activated, which ultimately sends the search string(s) to a database query processor or any other system for partial-match searching an encrypted index.

Search input 550 may appear within a browser of search input terminal 500, or within a dedicated application of search input terminal 500. In other exemplary embodiments, the search input may appear differently and include more advanced features. More advanced features may include controls for how the search string is broken into chunks, an option to upload a decryption key, input for authentication, etc.

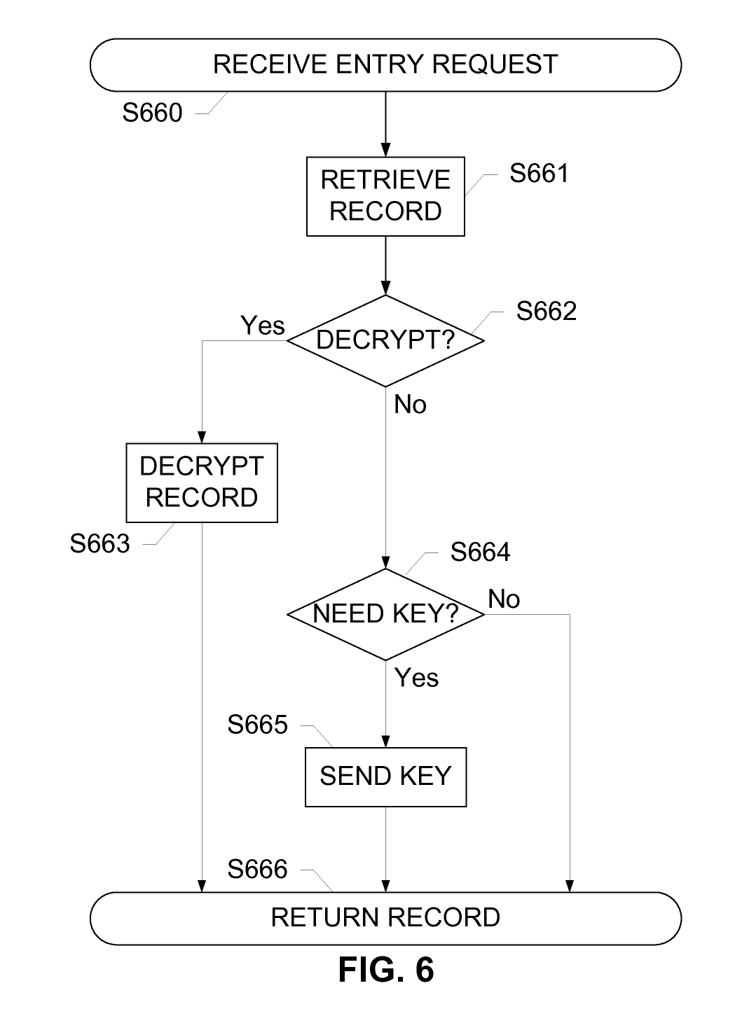

FIG. 6 shows a method for acquiring a record from a result of a partial-match search of an encrypted data set, according to an exemplary embodiment of the present subject disclosure. Upon receiving a result from a partial-match search of an encrypted index, a user (or system) performing the search may desire to view at least one full record listed in the result. The record is selected from the list of results, and a request for the full record is received by a database query processor or other system for providing requested records (S660). The record, which is encrypted within a database associated with the encrypted index, must be retrieved from the database (S661) to be returned to the user.

Along with the request for the record, a preference for encrypted or decrypted records may also be indicated (S662). If the preference is for decrypted records, then the record is decrypted (S663) before the record is returned (S666). If the preference is for encrypted records, then a decryption key may be returned along with the record. If the decryption key is needed (S664), then the decryption key is sent (S665), enabling the querying user/system to decrypt the returned encrypted record. In the event the decryption key is not needed, the record, either encrypted or decrypted, is returned (S666) to the querying user/system. The requested record may be returned via the search input system, or via any other record requesting system. Further, an authentication may be performed before the requesting user/system is allowed to request a record, or to submit a query. Additional authentication mechanisms may be deployed at any point in exemplary related methods, such as before returning a decryption key (S665).

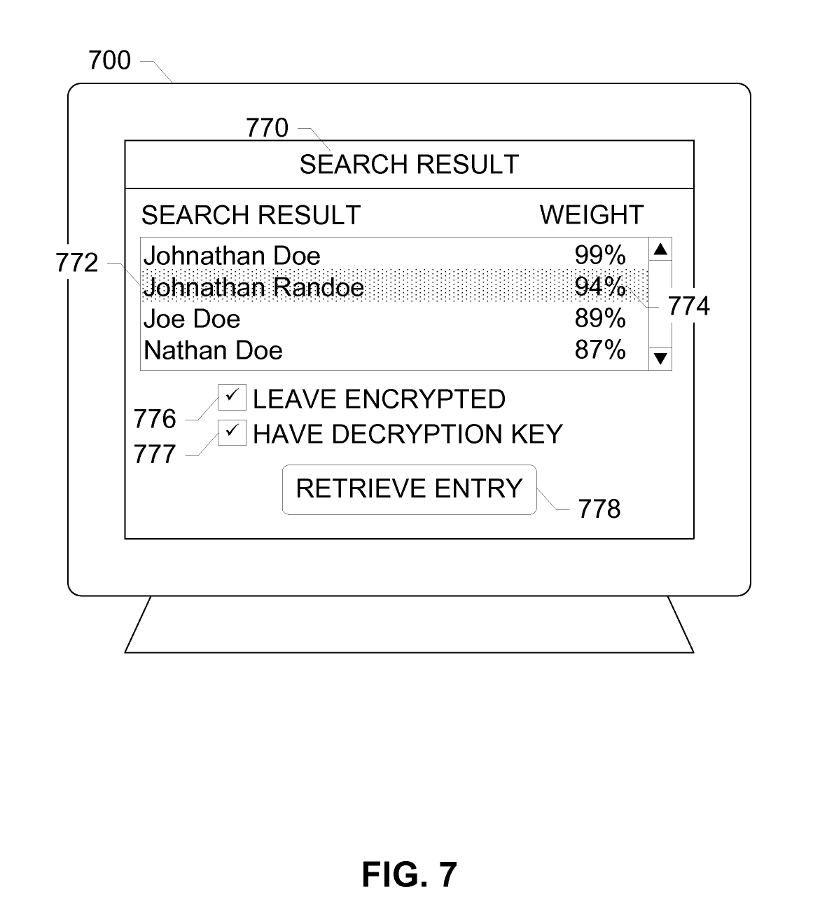

FIG. 7 shows an interface for requesting a record from a result of a partial-match search 770 of an encrypted data set, according to an exemplary embodiment of the present subject disclosure. Search result 770 is displayed on a search input terminal 700 of a search input system. A matching value 772 for each record having a match is displayed in a decrypted form, along with its assigned weight 774. Any matching value can be highlighted and a retrieval button 778 activated to request the associated record. Matching value 772 has been highlighted so that a copy of the associated record can be requested and viewed.

A user may further select option 776 to leave any requested records in an encrypted form. If no decryption key is needed, the user may further select option 777, indicating that they may already have the decryption key. Once at least one record has been highlighted, and options have been set accordingly, retrieval button 778 is activated. Upon activation, a request for the highlighted record(s) is sent along with the selection options to a database query processor or any other system for retrieving records from an encrypted database. In this and similar user interfaces, options, selections, and buttons, may be activated using input from a keyboard, mouse, touch-screen, etc. in communication with search input terminal 700.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A method for searching an encrypted database for a partial-match of a search string, the encrypted database including an index having a plurality of values and value chunks, each value having been broken into a plurality of value chunks, the index encrypted using a one-way encryption function, the method comprising:
breaking the search string into a plurality of search chunks;
wherein the search string and the plurality of search chunks are encrypted using the one-way encryption function prior to a comparison with the index to determine a matching value.

2. The method of claim 1, further comprising returning a search result including the matching value in the index based on the comparison.

3. The method of claim 2, wherein the search result includes a reference to a record associated with the matching value.

4. The method in claim 3, further comprising receiving a request for the record referenced in the search result.

5. The method in claim 4, further comprising decrypting the requested record using a two-way encryption function.

6. The method in claim 4, further comprising sending the requested record to a search input system.

7. The method in claim 1, wherein the breaking includes creating a chunk for each combination of at least three consecutive letters in the search string.

8. The method in claim 1, further comprising encrypting a plurality of records in the database using a two-way encryption function.

9. The method of claim 8, wherein the search string is related to a field within each record.

10. The method of claim 8, further comprising decrypting the value of only the field related to the search string, the decrypted value included in the search result.

11. The method of claim 1, further comprising receiving a search string from a search input system.

12. A system for partial-match searching an encrypted database, the system comprising:
a database server in communication with a search input system;
a database in communication with the server, the database storing a plurality of records and an index, the plurality of records encrypted using a two-way encryption function and the index encrypted using a one-way encryption function; and
a database query logic on the database server for breaking the search string into a plurality of search chunks,
encrypting the search string and each search chunk using the one-way encryption function, and
comparing the encrypted search string and each encrypted search chunk with the index to determine a matching value, the index having a plurality of values and value chunks, each value having been broken into a plurality of value chunks.

13. The system in claim 12, wherein the database server communicates with the search input system across a network.

14. The system in claim 12, wherein the database query logic is further for receiving a search string from the search input system.

15. The system in claim 14, wherein the database server receives the search string through a web portal.

16. The system in claim 12, wherein the database query logic is further for returning a search result to the search input system, the search result including a reference to each record associated with a matching value.

17. A computer-readable medium storing computer-readable instructions that, when executed by a processor, partial-search an encrypted database, the computer-readable medium comprising:
an instruction to break a search string into a plurality of search chunks;
an instruction to encrypt the search string and each search chunk using a one-way encryption function; and
an instruction to compare the encrypted search string and each search chunk to an index of the encrypted database to determine a matching value, the index having a plurality of values and value chunks, each value having been broken into a plurality of value chunks, the index encrypted using the one-way encryption function.

18. The computer-readable medium in claim 17, further comprising an instruction to receive a search string from a search input system.

19. The computer-readable medium in claim 17, further comprising an instruction to return a search result, the search result including the matching value.

20. The computer-readable medium in claim 19, further comprising an instruction to receive a request for a record referenced in the search result.
